(19) United States
(12) Patent Application Publication
(10) Pub. No.: US 2002/0184391 A1
(43) Pub. Date: Dec. 5, 2002

(54) Method and system for orderly communication of chat messages in a wirless network

(75) Inventor: W. Garland Phillips, Arlington, TX (US)

Correspondence Address: MOTOROLA INC, 600 NORTH US HIGHWAY 45, LIBERTYVILLE, IL, 60048-5343, US

(73) Assignee: MOTOROLA, INC.

(21) Appl. No.: 09/874,837

(22) Filed: Jun. 5, 2001

(51) Int. Cl. G06F 15/16

(52) U.S. Cl. 709/248; 709/204

(57) ABSTRACT

Chat messages are communicated with a plurality of wireless, including one or more wireless devices, over corresponding communication links. The present invention determines link latency associated with communicating a message with at least one wireless device and adjusts transmission timing of chat messages based on the link latency in order to provide orderly communication of chat messages.

### FIELD OF THE INVENTION

The present invention relates generally to the field of messaging. More particularly, the present invention relates to maintaining chat sessions in a wireless network.

### BACKGROUND OF THE INVENTION

Today, many users of wired devices, (such as personal computers or workstations) and wireless devices (such as, Personal Digital Assistants (PDAs), pagers, cellular telephones, etc.) are connected to the Internet. Generally, the users subscribe to services offered by various Internet Service Providers (ISPs), such as America Online and MSN. The services offered by the ISPs include the ability to send and retrieve files as well as messaging services.

Some of the most popular messaging services include e-mail and instant messaging (IM), which are supported over wired and wireless networks. E-mail, perhaps the most widely used service on the Internet, allows for non-real-time messaging between two users. On the other hand, IM, which allows a user to launch a message to another user, provides a substantially real-time messaging capability. Other known messaging services provide multiple simultaneous asynchronous sessions, such as conferencing and chat services. For example, Internet Relay Chat (IRC) or, simply “chat” provides informal communications among users of a communicating network. Chat allows two or more users to exchange messages, typically through “channels” or virtual “chat rooms,” which are maintained on one or more chat room servers operated by the ISPs. The chat room servers, which are accessible by the users via the Internet, provide the chat environment, including the mechanism for entering and exiting the chat rooms.

Only chat “participants” connected to the on-line service or other chat environment provided by one or more chat room servers can take part in the chat. Entering particular chat rooms is typically effected using a list or menu of currently available chat rooms, which are usually classified by topic. Any user may elect to join a public chat room and become a participant. Participants in a chat room receive all messages sent to the chat room and can decide to contribute input messages according to personal preference. A participant seeking to have private message communications with one or more other participants in an existing chat room can also set up a private chat room. Once an initiating participant sends a “query” or similar message to invited participants, the chat room server provides a separate chat room or channel not accessible by anyone that is not invited by those in the established private chat room. Once entered into a chat room, public or private, the participants engage in or monitor discussions on a particular topic in progress. Exiting a chat room is usually as simple as closing the chat window.

Typically, client stations, such as wireless devices or wired workstations or personal computers, execute general purpose chat “client” software that allows chat participants to access the chat room server. Many versions of chat client software with varying functionality and communications protocols, are widely available on the Internet for download. The chat room server, which maintains a list of all chat room participants, sends the chat messages to all of the participating client stations. The client stations, which can be wired or wireless devices, receive the messages over designated wired or wireless links.

Various wireless protocols are used for one-way and two-way messaging, including transmitting and receiving e-mail and chat messages. Communication systems that communicate voice and data messages are extensively used in telephony and wireless communication systems. For example, European Telecommunication Standard Institute (ETSI) has specified a Global Standard for Mobile Communication (GSM) that uses time division multiple access (TDMA) to communicate control, voice and data information over wireless radio frequency (RF) channels. In the U.S., Telecommunication Industry Association (TIA) has published a number of Interim Standards, such as IS-136, that define various versions of digital advanced mobile phone service (D-AMPS), and analog advanced mobile phone service (A-AMPS), with the capability of transmitting voice and data to subscribers.

One wireless system, which is disclosed in the U.S. Pat. No. 5,949,326, allows a pager user wireless access to the Internet via a paging system. The pager user may file an interest profile with the pager system service provider listing Internet sites from which the pager user desires information. The service provider accesses those sites and provides the information to the subscriber's pager either regularly or when signaled to do so by the pager user. The pager also includes an input device, such as a virtual keyboard, with which e-mail or chat room messages may be entered. The pager then transmits the messages to the paging system, which conveys them to the Internet.

Another known wireless protocol for connecting to the Internet is known as General Packet Radio Service (GPRS). GPRS is a non-voice value added service that allows information to be sent and received across GSM as well as the IS-136 systems. GPRS supplements today's Circuit Switched Data and Short Message Service (SMS) of the GSM at theoretical maximum speeds of up to 171.2 kilobits per second (kbps) using eight timeslots at the same time. Because of the spectrum efficiency of GPRS, there is less need to build in idle capacity that is only used in peak hours. GPRS, therefore, lets network operators maximize the use of their network resources in a dynamic and flexible way.

GPRS involves overlaying a packet based air interface on the existing circuit switched GSM network, thereby giving end users an option to use a packet-based data service. With GPRS, the information is split into separate but related “packets” before being transmitted and reassembled at a receiving end. Because of packet switching configuration of GPRS, radio resources are used only when end users are actually sending or receiving data. Rather than dedicating a radio channel to an end user wireless device for a fixed period of time, the available radio resource can be concurrently shared between several wireless devices, thereby allowing a large number of GPRS users to share the same bandwidth within a single cell. The actual number of users supported depends on the application being used and how much data is being transferred.

High immediacy is a very important feature for time critical applications. Subject to radio coverage, GPRS also facilitates instant connections whereby information can be sent or received immediately as the need arises. GPRS also facilitates new applications not previously available over GSM networks due to the limitations in speed of Circuit Switched Data (9.6 kbps) and message length of the Short Message Service (160 characters). For example, GPRS enables Mobile Internet functionality by allowing inter-working between the existing Internet and a GPRS-enabled network. As such, any service that is used over the fixed Internet today, for example, File Transfer Protocol (FTP), web browsing, chat, email, telnet, can also be available over the GPRS-enabled network.

The World Wide Web is becoming the primary communications interface, with users accessing the Internet. Hence, web browsing and providing web content are two important applications for GPRS. Because GPRS uses the same protocols as the Internet, the GPRS network can be viewed as a sub-network of the Internet with GPRS-enabled wireless devices being viewed as mobile hosts. This means that each GPRS-enabled wireless device can have its own IP address and be addressable as such.

Similar to wired Internet service providers, current wireless implementations transmit chat messages individually to each and every one of the wireless devices that are involved in a chat session, where many participants may be active in a given chat room. Some participants may be communicating over wireless links. These links typically have slower link latency than wired links. Thus, the wireless infrastructure may introduce delivery latency such that the chat messages may be received by the participants at different points in time and even out of order. Therefore, there exists a need for orderly communication of chat messages in a wireless network.

### DESCRIPTION OF THE DRAWINGS

FIG. 1 is a block diagram illustrating a communication system suitable for using an embodiment according to the present invention.

FIG. 2 illustrates a block diagram of a wireless network used in the communication system of FIG. 1.

FIG. 3 illustrates a GPRS protocol stack used in the communication system of FIG. 1.

FIG. 4 illustrates a diagram for a GPRS air interface in the communication system of FIG. 1.

FIG. 5 illustrates a sequential diagram for a base station initiated data transfer in the communication system of FIG. 1.

FIG. 6 illustrates a sequential diagram for a wireless device initiated data transfer in the communication system of FIG. 1.

FIG. 7 illustrates an electrical block diagram of a wireless device in accordance with the present invention.

FIG. 8 is a flow diagram of a chat communication method in accordance with the present invention.

### DESCRIPTION OF A PREFERRED EMBODIMENT

Briefly, according to the present invention, chat messages are communicated with a plurality of client devices, including one or more wireless devices, over corresponding communication links. The present invention determines link latency associated with communicating a message with at least one wireless device and adjusts transmission timing of chat messages based on the link latency in order to provide orderly communication of chat messages.

According to some of the more detailed features of the present invention, the link latency corresponds to a delay associated with transmitting a message and receiving a response from the at least one wireless device. In one exemplary embodiment, the link latency is determined using a low level network tool, such as PING. Moreover, the transmission timing of the chat messages can be adjusted by delaying a chat message transmission in accordance with a time reference derived from the link latency, for example, the link latency associated with the slowest device. Under this arrangement, the transmission timing of the chat messages can be delayed such that the chat messages arrive at the plurality of client devices at substantially the same time.

According to other more detailed features of the present invention, a communication system that communicates chat messages with a plurality of client devices includes a chat server that creates a chat room session for the plurality of client devices. A wireless network communicates messages addressed to one or more wireless device. Under this embodiment of the invention, the chat server determines the link latency associated with communicating a message with the wireless devices and adjusts the transmission timing of the chat messages based on the link latency. A client device with slowest link latency is informed of a link latency of a next slowest client device. The chat server transmits a message originated from the client with the slowest latency to other client devices with a delayed link latency that is based on the link latency of the next slowest client device. The message at the client with slowest latency is then displayed after a delay that accounts for the delayed link latency.

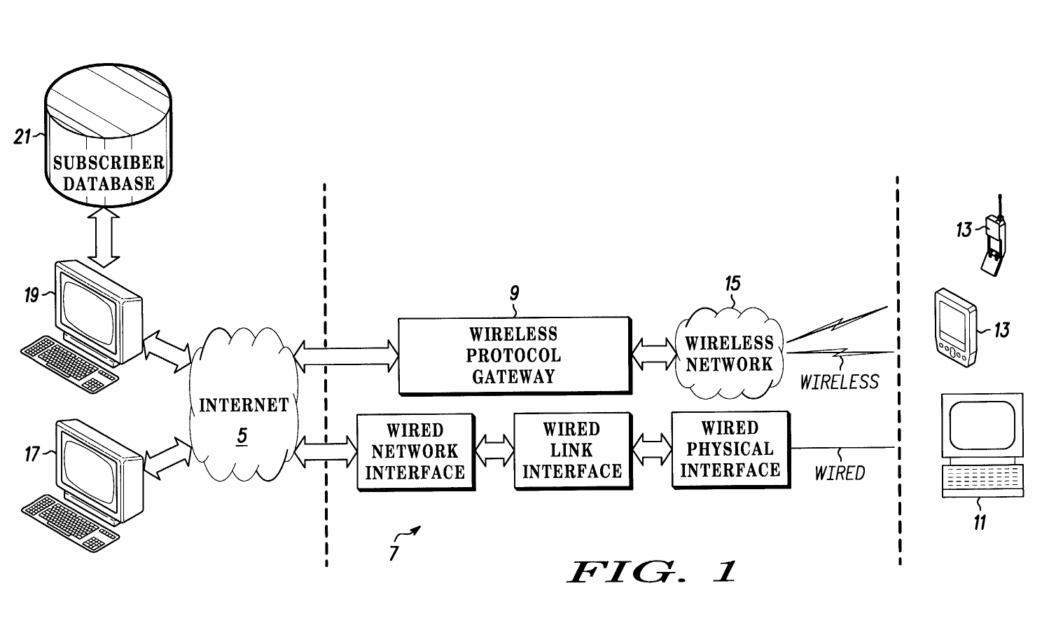

FIG. 1 shows a network interconnecting a plurality of wired devices 11 and wireless devices 13 to the Internet, for communicating chat messages in accordance with the present invention. The wired devices 11 access the Internet via a well-known wired Internet access network 7, such as a TCP/IP network. Each wireless device 13 is also provided with Internet access capability via a wireless network 15 connected to wireless protocol gateway 9. Examples of such wireless protocol gateway 9 are already defined or are in the process of being defined by such standard bodies as WAP Forum, 3GPP and 3GPP2. As such, in one exemplary embodiment, the wireless devices 13 may be in the form of WAP-enabled cell phones, two-way pagers, PDAs or any other type of device that wirelessly communicates information over a network. Also, the hardware platform for implementing the wireless network 15 can be any proprietary or standard hardware that supports wireless links with the wireless devices 13. Examples of such platform are those defined by GPRS, Flex, ReFlex, IS-95, IS-136, iDEN, Bluetooth, GSM, etc.

In accordance with chat room messaging embodiment of the present invention, each wired or wireless device 11, 13 is provided with capabilities to communicate chat messages via chat room servers 19, which are connected to the Internet 5. The chat room servers 19 can access a subscriber database 21, which stores subscriber related information and data. The subscriber database 21 stores name, wireless address and user profile information for each wireless device 13.

For communicating chat messages under one exemplary embodiment, the present invention supports any two-way wireless messaging/data protocol. The present invention can deploy any technology that supports PUSH protocols to send unsolicited messages to the wired and wireless devices 11, 13. For the wired communication of messages, well-known IM over TCP/IP technology can be used, where the wired devices 11 execute known chat client applications, such as those developed by America Online. For wireless communication of messages, wireless messaging protocols include short messaging service (SMS) and other similar messaging protocol, such as ReFLEX, which is developed by Motorola Inc., the assignee of the present invention. As such, the wireless devices 13, act as client device that communicate over TDMA, CDMA or other similar systems. Also the present invention can deploy in future versions of chat over WAP with WAP PUSH protocols where a WAP User Agent running under the WAP application environment (WAE) would be executed in a wireless device 13. Although the protocols described above are examples of the protocols that can be used, the present invention can be applied to any other suitable standard or proprietary application protocol.

Using the arrangement described above, the chat room server 19 gives each of the wired or wireless devices 11, 13 the capability of sending and receiving or otherwise communicating chat messages with other wired or wireless devices 11, 13. Upon receipt, the wired or wireless devices 11, 13 can immediately display the chat messages on a display device. The wired and wireless devices 11, 13 can also support buddy lists, which comprise lists with user identifications and statuses and/or locations of the users of each of the wired or wireless devices 11, 13. As described later in detail, the present invention equalizes the latency associated with chat messaging over a wireless network by adjusting the timing of transmission of the chat messages based on the link latency associated with a wireless device.

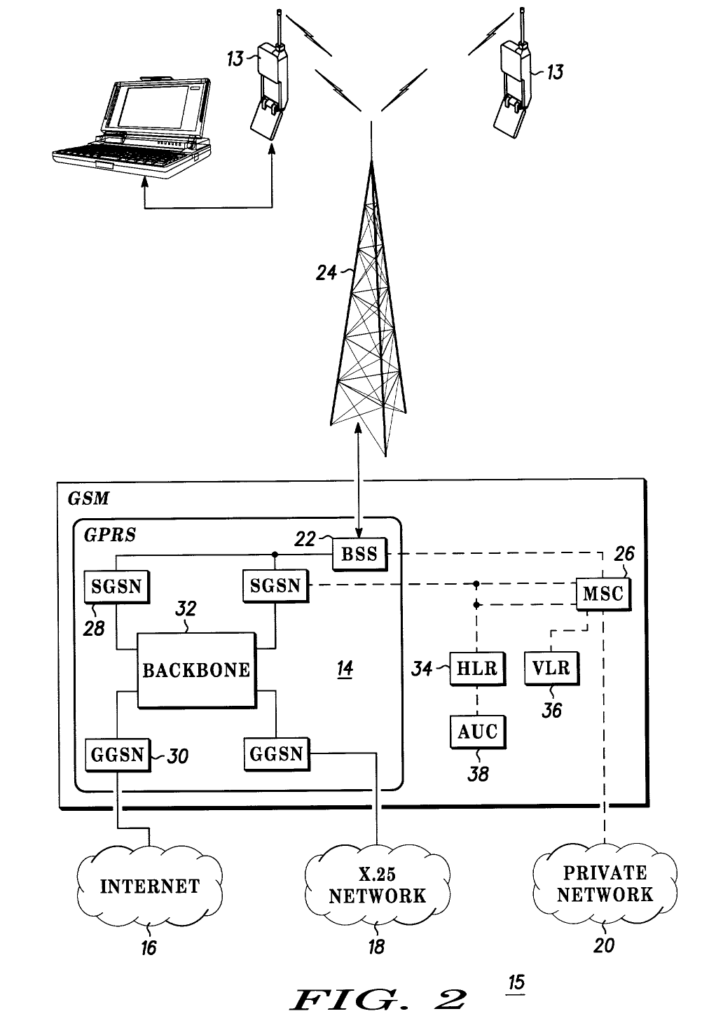

Referring to FIG. 2, a block diagram of an exemplary wireless network 15 that provides Internet access for wireless devices 13 of FIG. 1 is shown. The wireless network 15 is by way of example a GSM communication system, which provides wireless voice and data communication capability for the wireless devices 13. The mode of operation of a GSM communication system is described in European Telecommunication Standard Institute (ETSI) documents ETS 300 573, ETS 300 574 and ETS 300 578. Therefore, the operation of the system 10 is described only to the extent necessary to enable one skilled in the art to make and use the present invention. Although the present invention is described as embodied in a GSM system, those skilled in the art would appreciate that a wide variety of other communication systems, such as those based on Personal Digital Cellular (PDC), Digital Advanced Mobile Phone Service (D-AMPS), or Universal Mobile Telecommunication Standard (UMTS), or Code Division Access (CDMA) standards, can also be utilized.

The wireless network 15 is designed as a hierarchical network with multiple levels for managing calls and transmission of voice and packet data. Using an allocated set of uplink and downlink RF channels, a number of wireless devices 13 operating within the wireless network 15 participate in calls using allocated time slots that form logical communication channels. At a higher hierarchical level, a group of Mobile Service Switching Center (MSCs) 26 (only one is shown) are responsible for the routing of calls from an originator to a destination. In particular, they are responsible for setup, control and termination of calls and broadcasting of text messages.

At a lower hierarchical level, each MSC 26 is connected to a group of base station subsystems (BSS) 22 (only one is shown). The primary function of a BSS 22 is radio resource management. For example, based on reported received signal strength at the wireless devices 13, the BSS 22 determines whether to initiate a hand over. Under the GSM standard, the BSS 22 communicates with the MSC 26 using a standard interface known as the A-interface. At a still lower hierarchical level each one of the BSS 22 control a group of base transceiver station (BTS) 24. Each BTS 24 includes a number of transceivers (TRXs) that use the uplink and downlink RF channels to serve a particular common geographical area. Therefore, The BTS 24 primarily provide the RF links for the transmission and reception of data bursts to and from the wireless device 13 within their designated cell.

In an exemplary embodiment, the mobile data messaging service of the wireless network 15 is provided by a GPRS defined standard. A GPRS network 14 deployed in the wireless network 15 utilizes the existing GSM nodes, in addition to others, for supporting packet switching, and inter-working with existing packet data networks, such as the Internet 16, X-25 network 18 and a private network 20. In this way, various types of content, such as chat messages, can be communicated to the wireless devices 13. The wireless devices 13 are also equipped to handle GPRS provided mobile packet data service, in addition to handling voice service. Examples of such wireless devices 13 include smart phones, Personal Digital Assistants (PDA), or portable computers, such as a lap tops, or palm tops that operate with or without a cellular telephone.

While voice traffic is routed to the MSC 26, GPRS packets carrying the various types of content are sent from the BSS 22 to a Serving GPRS Support Node (SGSN) 28. The SGSN 28 is the node within the GSM infrastructure that sends and receives packet data to and from the wireless devices 13, while keeping track of the wireless devices 13 within a covered service area. The SGSN 28 communicates with a Gateway GPRS Support Node (GGSN) 30, via a backbone network 32, which is a system that maintains connections with other networks such as the Internet 16, X.25 networks 18 or private networks 20. The GPRS network 14 can use multiple serving nodes, but requires only one gateway node for connecting to an external network such as the Internet 16.

The wireless device 13 sends packets of data via the SGSN 28 to the GGSN 30, which converts them for transmission over a desired network. As mentioned above, the desired network could be the Internet 16, X.25 networks 18 or private networks 20. For example, data packets representing web content and chat messages from the Internet 16 addressed to the wireless device 13 are received by the GGSN 30, forwarded to the SGSN 28 and then transmitted to the wireless device 13. To forward IP or X.25 packets between each other, the SGSN 28 and GGSN 30 encapsulate these packets using a specialized protocol called the GPRS tunnel protocol (GTP), which operates over the top of standard TCP/IP protocols.

The MSC 26 and SGSN 28 are associated with corresponding Home Location Registers (HLR) 34 and Visitors Location Registers (VLR) 36, which maintain user/subscriber information for roaming and billing purposes. An Authentication Center (AUC) 38 provides authentication functionality when placing voice and data calls. As illustrated by the dotted lines, the VLR 36 and HLR 34 and AUC 38 need not be physically associated with the location of a MSC 26 or SGSN 28, since the network gives full connectivity to all of the associated components and nodes. Generally, the MSC 26 is also connected to a public switching telephone network (PSTN), to give connectivity between fixed landline subscribers and mobile subscribers.

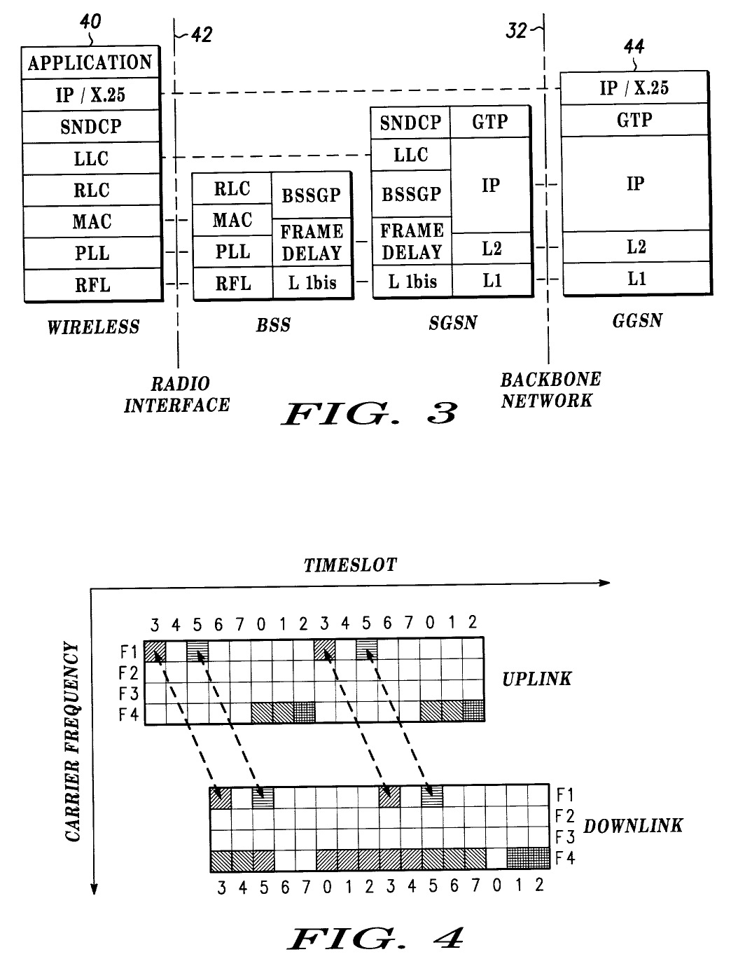

Referring to FIG. 3, communication protocol stack 40 for communicating data packets between the wireless network 15 and the wireless devices 13 is shown. Among other things, the protocol stack 40 comprises: a sub-network dependent control protocol (SNDCP) layer that encrypts and compresses data packet segments; a logical link control (LLC) layer that links an underlying air or radio interface to the SGSN 20; a radio link control (RLC) layer that supports error correction; a medium access control (MAC) layer that supports slotted ALOHA scheme; a physical link sub-layer (PLL) that frames and codes the packets and also manages the physical medium error; and a radio frequency layer (RFL) that modulates and demodulates the transmitted packet over the radio frequency channels. The details of the SGSN 28 and GGSN 30 are both invisible and irrelevant to the user who simply experiences a straightforward IP or X.25 connection that just happens to be wireless. As stated above, the radio frequency channels in the GSM/GPRS implementation are divided into repetitive frames comprising 8 time slots. At the radio interface 42 the IP/X.25 packet 40 is converted to a necessary protocol stack 44 used in a wired network.

Referring to FIG. 4, a diagram illustrates the air interface for the wireless network 15. As shown, the communication channels comprise radio frequency (RF) channels having specified carrier frequencies. In the wireless network 15, an RF channel (uplink or downlink) is divided into repetitive time frames during which voice and date are communicated. Each frame, which can be a super-frame or a hyper-frame, is further divided into time slots or logical channels that carry packets of information. Speech is transmitted during logical channels designated as traffic channels (TCH). All signaling functions pertaining to call management in the system, including initiation, hand over, and termination are handled via information transmitted over signaling channels, which can be dedicated or associated signaling channels. The functions of some of the dedicated signaling channels are:

Broadcast Control Channel (BCCH), which is transmitted at the first time slot (time slot 0) of the downlink RF channel, provides the wireless devices with information about the BTSs, such as a BTS identity.

Standalone Dedicated Control Channel (SDCCH), which is transmitted at a time slot adjacent to the BCCH, is used for registration, location updating, authentication and call set-up.

Paging channel is a downlink only channel, for informing the mobile unit of a network signaling requirement, for example when the wireless device is called.

Access Grant Channel is a downlink only channel used for replies to access requests, for assigning a dedicated control channel for subsequent signaling.

Some of the individual functions of the associated signaling channels are defined below:

Slow Associated Control Channel (SACCH) is used for communicating control and supervisory signals associated with a number of traffic channels, including the transmission of an RX-QUAL parameter that corresponds to a measure of bit error, and an RX-LEV parameter that correspond to a measure of received signal strength at the mobile unit.

Fast Associated Control Channel (FACCH) steals time slots allocated for associated traffic channels for control requirements, such as handover.

Referring to FIG. 5, a sequential diagram illustrates a base station initiated data transfer 46 in accordance with the present invention. In the data transfer, the base station subsystem 22 (BSS) sends a packet paging request to the wireless device 13 to initiate the data transfer 46 process. In response, the BSS 22 assigns and transmits a packet channel assignment to the wireless device 13. In response to the wireless device 13 sending a packet paging response and receiving a packet resource assignment, the BSS 22 transmits packet data and continues with various acknowledgements and error checks for presenting content to a user in accordance with the present invention.

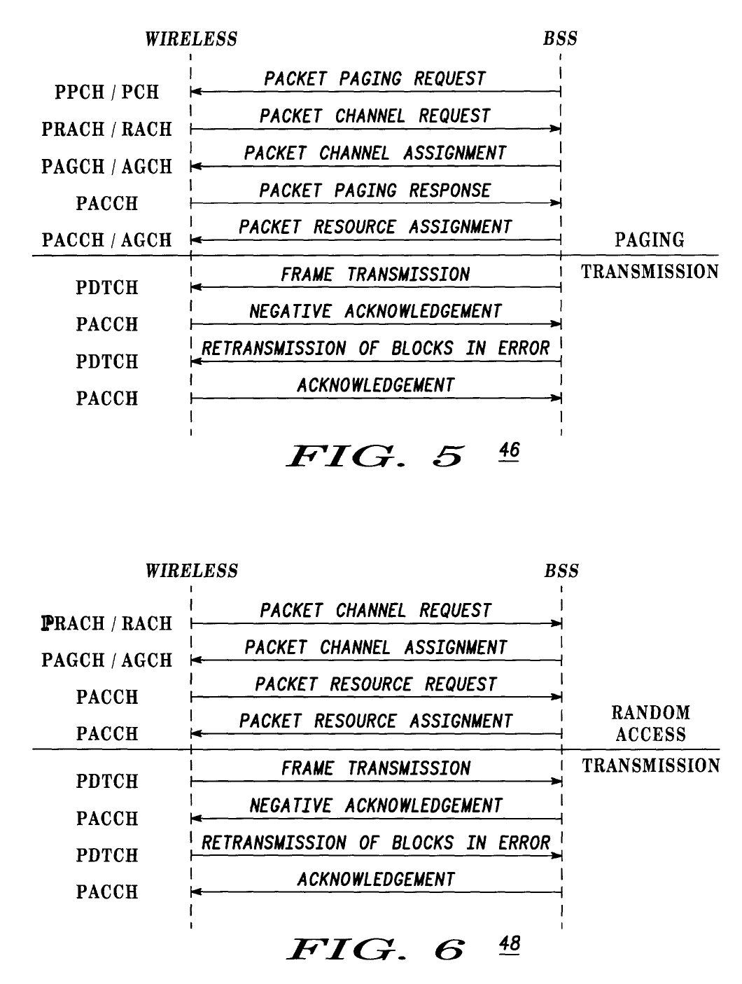

Referring to FIG. 6, a sequential diagram illustrates a wireless device initiated data transfer 48 in accordance with the present invention. In the wireless device initiated data transfer 48 process, the wireless device 13 sends a packet channel request to the BSS 22, requesting a transmission frequency channel and time slots. Once the wireless device 13 receives the packet frequency channel assignment, the wireless device 13 sends a packet resource request, referred to as a communication resource allocation request, to the BSS 22. The BSS 22 then assigns resources to the wireless device 13 which can, for example, correspond to a number assigned time slots. The wireless device 13 then transmits and receives packet data and continues with the various acknowledgements and error checks which completes content communication in accordance with the present invention.

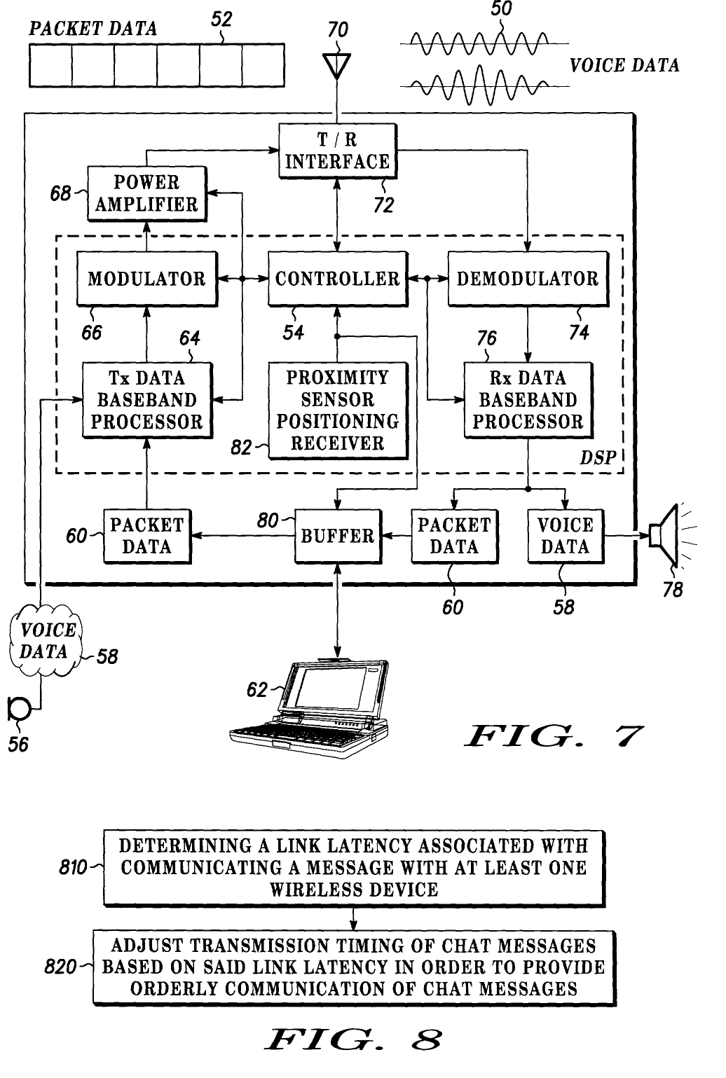

Referring to FIG. 7, a block diagram of a wireless device 13 that incorporates the present invention is shown. Along with a voice service, the wireless device 13 supports a data service. Using the data service, a wireless device user can be presented with web content and messages over the RF channels. In the preferred embodiment of the present invention, the wireless device 13 is a portable two-way device that operates in transmit and receive modes for communicating voice data 50 and packet data 52 over one or more RF channels. In one exemplary embodiment, the wireless device 13 can be operating within the wireless network 15 of FIG. 2, which provides a voice and data service within a coverage area using the GSM/GPRS protocols. As stated above, the wireless device 13 can be employed in a wide range of wireless networks 15, including systems that are based on the GSM and IS-136 standards. With any one of these systems, a user can use the wireless device 13 of the present invention to establish chat communication.

The wireless device 13 operates under the control of a controller 54 which provides a duplex data communication under a specified communication protocol. In the exemplary embodiment of the present invention, the controller 54 is programmed to provide the duplex communication service under radio frequency channels that are divided into repetitive time frames. Under GSM protocol, for example, each time frame is divided into 8 time slots.

In the transmit mode, the wireless device 13 includes a microphone 56 that produces a voice signal that corresponds to the user's voice. The voice signal is converted to voice data 58. The wireless device 13 under the control of the controller 54 also produces packet data 60, for example, based on user input as received from a user interface 62. A transmit-data baseband processor 64 processes the voice data 58 and packet data 60 originated at the wireless device 13. Based on a specified modulation technique, a modulator 66 modulates the baseband-processed voice data 58 and packet data 60 to produce a modulated signal. A power amplifier 68 amplifies the modulated signal to generate an amplified modulated communication signal at a specified frequency or frequency spectrum. The amplified communication signal is radiated via an antenna 70 through an TX/RX interface 72 that facilitates the duplex data communication under the control of the controller 54. The antenna 70 can be any one of an antenna known to those skilled in the art, for example, a monopole antenna, a dipole antenna, an array of dipole antennas, a micro strip antenna, and a plasma antenna.

In the receive mode, the wireless device 13 receives electromagnetic radiation at the antenna 70. The received electromagnetic signal received at the antenna 70 is demodulated using a demodulator 74 and is coupled to a receive-data baseband processor 76 through to the TR/RX interface 72. The communication signal is segregated into the content packet data 60 and the voice data 58 using the receive-data baseband processor 76. The voice data 58 is properly routed to a speaker 78 in order to convert the communication signal into audible sound. The content packet data 60 is routed to a buffer 80, which manages the packet data 60. The content packet data 60 can then be loaded onto the user interface 62 for user interaction, for example, to present images to the user on a display device. The wireless device 13 can also include a proximity sensor or a positioning receiver 82 that provide proximity information, e.g., coordinates of the wireless device 13, to the controller 54. It would be appreciated that the data processing and control functions can be incorporated into a well-known DSP that is programmed to for example perform baseband processing and other functions.

According to the present invention, the delivery of chat messages is managed so that participants receive the messages in an orderly manner, preferably, at approximately the same time. Referring to FIG. 8, the flow chart of a method for delivering chat messages in accordance with the present invention is shown. In order to manage message delivery, the chat server 19 determines a link latency associated with a communication link used by one or more wireless devices 13 that participate in a chat session, block 810. The transmission timing of chat messages is adjusted relative in order to provide orderly chat message communication amongst the participants, block 820.

In one exemplary embodiment, the link latency relates to a delay associated with communicating a message with each participant. Generally, the chat server 19 estimates a one-way delay by dividing the roundtrip delay by two. For determining the delay, one exemplary embodiment uses a protocol that tests the reach-ability of destinations by sending them one, or repeated, echo requests and waiting for replies. Preferably, the protocol would work at IP level or another low level protocol for testing whether a remote host is responding or not. One exemplary protocol is the Ping tool, which often responds even when higher level, TCP-based services cannot respond. Depending on the wireless network, there may be alternate ways to measure link latency. It is also possible that the device could be pre-configured with a latency value which could then be provided to the chat server 19 on login or upon request. Rather than pre-configure, a device could determine its link latency itself.

The chat server 19 can also use a determined delay as a time reference relative to which chat messages are transmitted. The transmission timing of chat messages can then be adjusted relative to such time reference in order to synchronize the communication of chat messages. More specifically, in another exemplary embodiment, a participant with the longest link latency or delay is designated as a pacer participant for an ongoing chat session. The chat messages transmitted to each of the other participants, except, the pacer participant, are delayed by an amount that makes all chat messages arrive at each destination at approximately the same time or otherwise in an orderly manner. However, the timing of the chat messages to or from the pacer participant are not adjusted or delayed.

For example, if transmissions to a pacer participant have a one-way link latency or delay of one minute and transmissions to another participant have a one-way link latency or delay of 0 seconds, then the chat server 19 delays the transmission of all messages to the other participant by one minute. In this manner, the chat messages would arrive at both participants substantially simultaneously. The chat server 19, thus, uses the roundtrip time information to bring all participants to equal footing with regard to latency in an ongoing chat session. This is accomplished by delaying new messages to those participants who have fast links, by enough amount that all participants are equalized from the perspective of message latency.

The chat server 19 can reduce the delivery delay introduced for messages submitted by the pacer participant. Under this arrangement, the pacer participant is informed by the chat server 19 of the one-way latency of the next slowest client device. When the pacer submits a message, the one-way delivery latency target used by the server 19 is reduced to that of the next slowest participant. The pacer participant may then display its own message after a delay that accounts for the reduced delivery latency in use by the chat server 19. All participants get the new message with latency equal to next slowest client device.

Moreover, chat messages from participants with low latencies may be additionally delayed to account for the inbound latency, thereby properly synchronizing chat message transfers. The chat server 19 could periodically perform link latency measurements to detect link latency status changes. Alternatively, the client devices could inform the chat server 19, when their link latency changes.

Normally, the delay used in the system is chosen to allow for participation by participants having slowest link latency. If that slowest participant is not planning to submit messages, then the latency of the next slowest participant can be used to determine the delay. Under this arrangement, any introduced delay would be because of the next slowest participant. Preferably, the present invention does not delay transmission of chat messages to the slowest participant that is receiving or otherwise listening to the communicated chat messages. In other words, as long as a participant does not participate in a chat session by inputting a message, the chat session is not slowed down. With this action, that slowest participant would get a little behind in the chat stream but it would not affect anyone because the participant is not planning to input messages.

In one exemplary embodiment, participants register with or otherwise inform the chat server 19 of their intent to participate in a chat session. The chat server 19 would then take their link latency into consideration for adjusting the transmission timing of the chat messages.

The chat server 19 can allow configuration of a maximum allowable link latency for any given chat room. For example, slower linked participants could be excluded from participating in a chat session, but they may still be allowed to listen and follow a chat discussion. Submitted messages may be displayed by a submitter's client device itself so that the chat server 19 need not deliver that message back to a message submitter. These messages are best displayed after delay so that messages stay synchronized.

What is claimed is:

1. A method of communicating messages with a plurality of client devices that include one or more wireless devices over a communication link, comprising:
determining a link latency associated with communicating a message with at least one wireless device; and
adjusting transmission timing of chat messages based on said link latency in order to provide orderly communication of chat messages.

2. The method of claim 1, wherein the link latency corresponds to a delay associated with communicating a message with at least one wireless device.

3. The method of claim 1, wherein the transmission timing of the chat messages is adjusted by delaying a chat message transmission in accordance with a time reference derived from the link latency.

4. The method of claim 1, wherein the transmission timing of the chat messages is delayed such that the chat messages arrive at the plurality of client devices at substantially the same time.

5. The method of claim 1, wherein the link latency is determined using a low level network protocol.

6. The method of claim 1, further including:
informing a client device with slowest link latency of a link latency of a next slowest client device;
transmitting a message from the client device with the slowest latency to other client devices with a delayed link latency that is based on the link latency of the next slowest client device; and
displaying a chat message originated at the client with slowest latency after a delay that accounts for the delayed link latency.

7. The method of claim 1, wherein said latency measurement is repeated over time.

8. A communication system that communicates chat messages with a plurality of client devices wireless device over a communication link, comprising:
a chat server that creates a chat room session for the plurality of client devices;
a wireless network that communicates messages addressed to at least one wireless device, wherein the chat server determines a link latency associated with communicating a message with the at least one wireless device and adjusts transmission timing of chat messages based on said link latency in order to provide orderly communication of chat messages.

9. The communication system of claim 8, wherein the link latency corresponds to a delay associated with communicating a message with at least one wireless device.

10. The communication system of claim 8, wherein the transmission timing of the chat messages is adjusted by delaying a chat message transmission in accordance with a time reference derived from the link latency.

11. The communication system of claim 8, wherein the transmission timing of the chat messages is delayed such that the chat messages arrive at the plurality of client devices at substantially the same time.

12. The communication system of claim 8, wherein the link latency is determined using a low level network protocol.

13. The communication system of claim 8, wherein a client device with the slowest link latency is informed of a link latency of a next slowest client device, wherein the chat server transmits a message originated from the client device with the slowest latency to other client devices with a delayed link latency that is based on the link latency of the next slowest client device.

14. The communication system of claim 1, wherein said latency measurement is repeated over time.
